(19) United States
(12) Patent Application Publication
(10) Pub. No.: US 2006/0253423 A1
(43) Pub. Date: Nov. 9, 2006

(54) Information retrieval system and method

(76) Inventors: Mark McLane, Middleton, WI (US); Kevin Runde, Verona, WI (US); Gregory Sellek, Verona, WI (US)

Correspondence Address: MICHAEL BEST & FRIEDRICH, LLP, 100 E WISCONSIN AVENUE, MILWAUKEE, WI, 53202, US

(21) Appl. No.: 11/124,623

(22) Filed: May 7, 2005

(51) Int. Cl. G06F 17/30

(52) U.S. Cl. 707/2

(57) ABSTRACT

An information retrieval system having a structured data store; and a signature generator configured to receive data from the structured data store, to create a category signature based on the data received from the structured data store, to receive search results from at least one crawler, and to generate a document signature based on the results from the at least one crawler. The system may also include a data store populated with a set of category signatures; and a search utility configured to receive a seed and to provide the seed to a plurality of search engines. Each search engine may be configured to generate a search result set, to parse each search result set, and to return a relevant data set. The crawler is configured to receive the relevant data set and to generate a second set of search results with a relevancy to a category. A signature comparator receives at least one document signature and at least one category signature and compares the two. The signature comparator generates flagged records based on the comparison and an indexed data store is populated with flagged records.

### BACKGROUND

Embodiments of the invention relate to an information retrieval system that returns relevant records in response to a query. One embodiment is related to a system for learning aspects of a topic from a structured data store and using this knowledge to search for relevant data in an unstructured store of information.

Various data-mining, database-query, and search-engine technologies are known. Data-mining and database-query technologies are often used to analyze relatively organized data, such as relational databases and business transactions. Search engines are often used to search relatively unorganized data, such as the Internet. Internet search engines are useful, especially when considering the amount of information processed. However, as anyone who has used Yahoo!, Google, or similar search engines can attest to, finding relevant information is not always as easy and quick as might be desired.

### SUMMARY

There are a number of situations in which improved data analysis and searching techniques and technologies would be useful. The legal industry, in particular, the trademark industry, is an industry in which such searching capabilities would be useful. Currently, the selection of a new trademark (often referred to as “the birth of a new brand”) involves examining the status of the proposed new trademark against the registered trademarks in public, structured data sources such as the United States Patent & Trademark Office (“USPTO”) database of registered trademarks. The advent of the World Wide Web has created a conundrum for legal and branding professionals in performing required due diligence for proper registration of a new trademark.

The Internet provides users with the potential to access a tremendous amount of information. As noted, however, finding Internet-based information is often time consuming and cumbersome. Search engines require a user to enter search terms (called a “search query”). The search engine provides a list of search results. The list consists of a number of Web links. Typically, such a list is generated by matching the terms in the search query to a body of pre-stored Web documents. Web documents that contain the user's search terms are considered “hits” and are returned to the user. A general purpose search engine may return millions of unrelated web pages which contain the term somewhere on the page, or, alternatively, somewhere hidden from view as an embedded identifier, such as, a metatag. Therefore, there is a need to improve technologies for searching unstructured data stores.

Accordingly, in one embodiment the invention provides a system and method for associating categories of information such as the International Schedule of Classes of Goods and Services (the “International Classes of Trade”) to Internet content and established database content. In one embodiment, a relevancy index based on the International Classes of Trade is used for an unstructured data store (such as Internet content) and a structured data store (such as a database) to deliver relevant search results that may be actively managed via a workflow process. In some embodiments, users can manipulate and share data. Users can further review and analyze data with an integrated set of workflow tools. The tools allow users to customize their searches based on relevancy and share the results collaboratively.

An information retrieval system is provided in another embodiment. The information retrieval system may include a structured data store; and a signature generator configured to receive data from the structured data store, to create a category signature based on the data received from the structured data store, to receive search results from at least one crawler, and to generate a document signature based on the results from the at least one crawler. The system may also include a data store populated with a set of category signatures; and a search utility configured to receive a seed and to provide the seed to a plurality of search engines. Each search engine may be configured to generate a search result set, to parse each search result set, and to return a relevant data set. At least one crawler is configured to receive the relevant data set and to generate a second set of search results with a relevancy to a category. Generally, the second set of results is larger than the first set of results. A signature comparator receives at least one document signature and at least one category signature and compares the two. The signature comparator generates flagged records based on the comparison and an indexed data store is populated with the flagged records from the signature comparator.

A method of creating a structured data store from an unstructured data store is provided in another embodiment. The method may include generating search results from a search of the unstructured data store; providing the search results to a signature generator to create a document signature; generating a category signature based on information from a structured data store; providing the document signature and the category signature to a signature comparator to generate a flagged record; and populating a data store with the flagged record.

In another embodiment an information retrieval system is provided. The system includes an indexed data store containing data from a plurality of structured and unstructured data stores, and a query builder. The query builder can choose at least one of the plurality of structured and unstructured data stores to include in a query, select fields related to the at least one data store chosen, and accept criteria from a user interface for the selected fields. The system also includes a search utility to search the indexed data store and return results matching the query built.

The system may be configured to operate on an Internet portal, to group and display results according to a data store origin, to display data for each result, and to create categories based on correlated data in the results. Results may be displayed by category and each result may be linked to a record in the indexed data store. In addition, each result may be linked to a record in a data store of origin. A user may select zero or more results for entry in a data store and select results to be flagged. A user may also annotate results and generate a report. A plurality of users may have access to the same reports, results, or both.

Other features and aspects of embodiments will become apparent from a review of the drawings and detailed description.

### BRIEF DESCRIPTION OF THE DRAWINGS

In the drawings:

FIG. 1 is an illustration of elements in an information retrieval system and their relationship to one another.

FIG. 2 illustrates a process of populating a category signature data store.

FIG. 3 is an illustration of a process for retrieving relevant records from an unstructured data store for delivery to a signature generator.

FIG. 4 is an illustration of a utility to retrieve relevant records utilizing search tools.

FIG. 5 is an illustration of a process for determining the relevancy of a document and indicating the existence of relevancy.

FIG. 6 illustrates the steps executed in the illustration of FIG. 5.

FIG. 7 illustrates the steps executed in a signature generator.

FIG. 8 illustrates an exemplary workflow message center.

FIG. 9 illustrates an exemplary workflow query builder and management screen.

FIG. 10 illustrates an exemplary workflow results screen for a structured data store.

FIG. 11 illustrates an exemplary workflow results screen showing categorization.

FIG. 12 illustrates an exemplary workflow results screen showing an alternative categorization.

FIG. 13 illustrates an exemplary view of a trademark online presence window.

FIG. 14 illustrates an exemplary workflow query builder for an unstructured data store.

FIG. 15 illustrates an exemplary workflow results screen for an unstructured data store.

FIG. 16 illustrates an exemplary workflow summary screen.

FIG. 17 illustrates an exemplary workflow results summary screen for a structured data store.

FIG. 18 illustrates an exemplary workflow detailed record screen and tools.

FIG. 19 illustrates an exemplary workflow reporting screen.

### DETAILED DESCRIPTION

Before embodiments of the invention are explained in detail, it is to be understood that the invention is not limited in its application to the details of the examples set forth in the following description or illustrated in the drawings. The invention is capable of other embodiments and of being practiced or carried out in a variety of applications and in various ways. Also, it is to be understood that the phraseology and terminology used herein is for the purpose of description and should not be regarded as limiting.

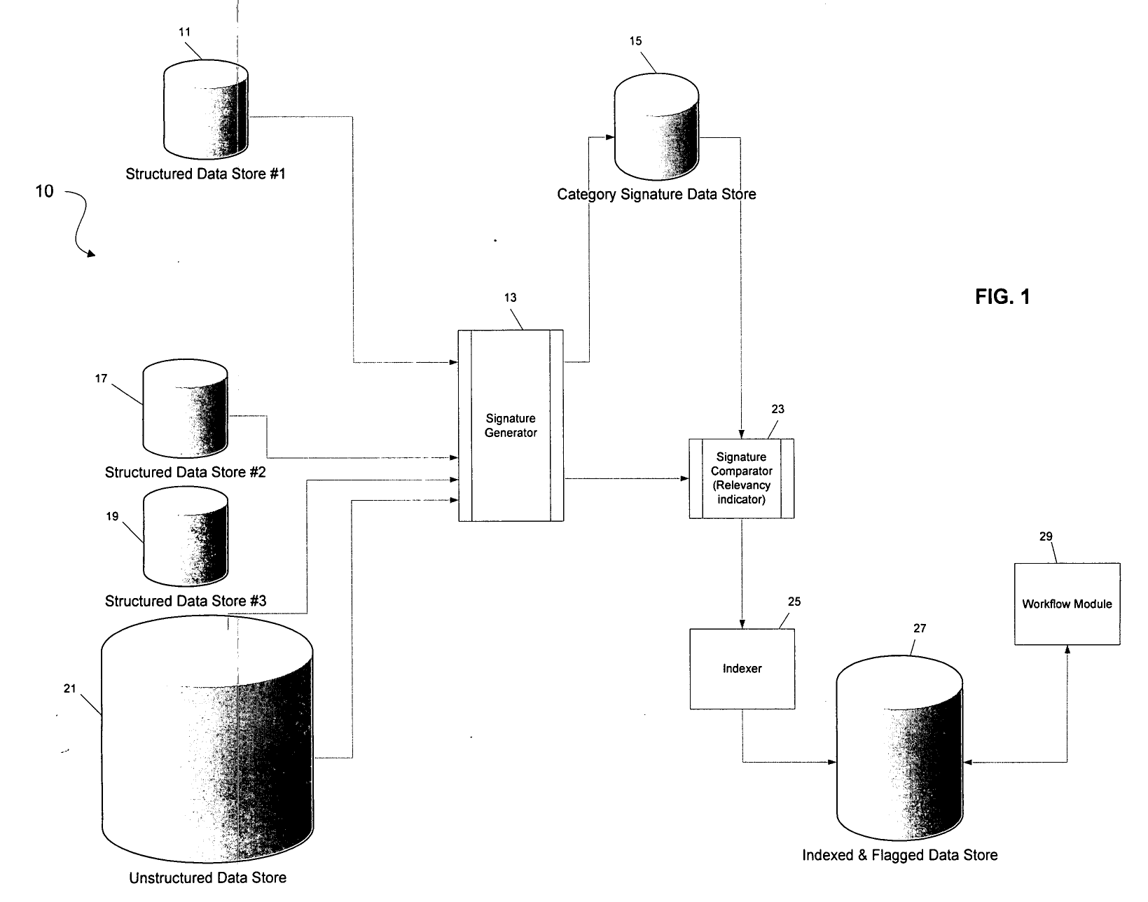

An information retrieval system 10 is shown in FIG. 1. The system contains a first structured data store 11. The structured data store 11 could take the form of the USPTO database of registered trademarks, but other structured data stores could be used. A variety of information, topics or subjects could be used to build the data store. Non-limiting examples include medical information, information regarding automobiles, and the works of Shakespeare. In this description, examples involving trademark information are provided, but numerous variations are possible. For example, the structured data store could be populated with pricing information for automobiles and processing of information from an unstructured data store (which is described below) could also relate to automobile prices. Thus, numerous embodiments beyond the examples provided are possible.

The data store 11 includes a number of records or documents. Each document includes a set of information. For example, in the case of a trademark registration, a document may include the following information: a trademark name or illustration, a registration number, a name of the trademark owner, the date of registration, the International Class of the trademark, and the like. (To continue the prior example of automobiles, a record could include make, model, year, color, and price.) All documents related to a single category, in this case one of the International Classes of Trade, are provided to a signature generator 13, one category at a time, such that a unique signature is generated for each category (or International Class of Trade). The signatures are then stored in a category signature data store 15 (e.g., a matrix held in a computer's memory). Documents from other structured data stores 17 and 19 (e.g., a database of Canadian trademark registrations) or from an unstructured data store 21 (e.g., the Internet) are provided to a signature generator 13. A unique signature, for each document, is generated by the signature generator 13 and provided to a signature comparator 23. The signature comparator 23 compares the document signature to all the category signatures in the category signature data store 15. A document that is relevant to a category has an indicator that represents its association to the category amended to it. A process of amending an indicator to a document is referred to as adding a flag or flagging. A document may be relevant to more than one category. A flag is amended to a document for all categories to which the document is related. Flagged documents are then indexed at an indexer 25 and stored in an indexed and flagged data store 27. A workflow module 29 provides a means for users to search and extract relevant documents from the indexed and flagged data store 27.

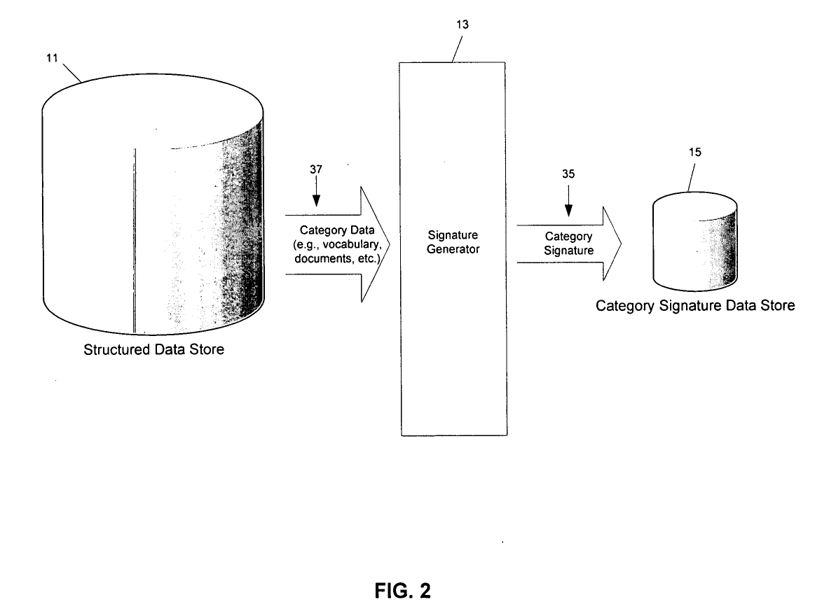

In one embodiment of the invention, shown in FIG. 2, the structured data store 11 contains a vocabulary of terms. In the example described herein, the vocabulary includes 20,000 terms, but vocabularies of other sizes could be used. The terms are descriptive of a plurality of distinct categories (e.g., the International Classes of Trade). A term is a word, a group of words, or a phrase. A subset of the vocabulary exists for every category that describes the category. The subset of terms for each category (e.g., the International Classes of Trade) is provided to the signature generator 13. The signature generator 13 creates a unique signature 35 for each category. An example signature is shown in TABLE 1 (which corresponds to a category signature, where a one represents a term from the vocabulary that is part of the description for International Class (“IC”) 1 and a zero represents a term from the vocabulary which is not part of the description for International Class 1.

TABLE 1

| | IC1 |
|---|---|
| Term 1 | 0 |
| Term 2 | 0 |
| Term 3 | 1 |
| . | . |
| . | . |
| . | . |
| Term 20000 | 1 |

The category signature 35 is stored in the category signature data store 15. The category signature data store 15, in one embodiment, could be a matrix stored in a computer's memory. In another embodiment the category signature data store 15 could be a database on a storage media. The category signature generation process is repeated for all of the categories represented in the structured data store 11, which in the case of trademark information could be all forty-five International Classes of Trade.

Instead of a vocabulary, the structured data store 11, could contain groups of documents 37, such as documents or records from the USPTO's Trademark database of registered trademarks. The documents are grouped together in categories (e.g., International Classes of Trade). All documents in the structured data store 11 that relate to a specific category, in this case one of the International Classes of Trade, are provided to the signature generator 13. As noted, the signature generator 13 creates a unique signature 35 which represents all documents 37 from the structured data store 11 for a specific category. The method of generating a signature could be a method that uniquely identifies a record set. Such methods may include Latent Semantic Indexing or Natural Language Processing or the vocabulary method described herein.

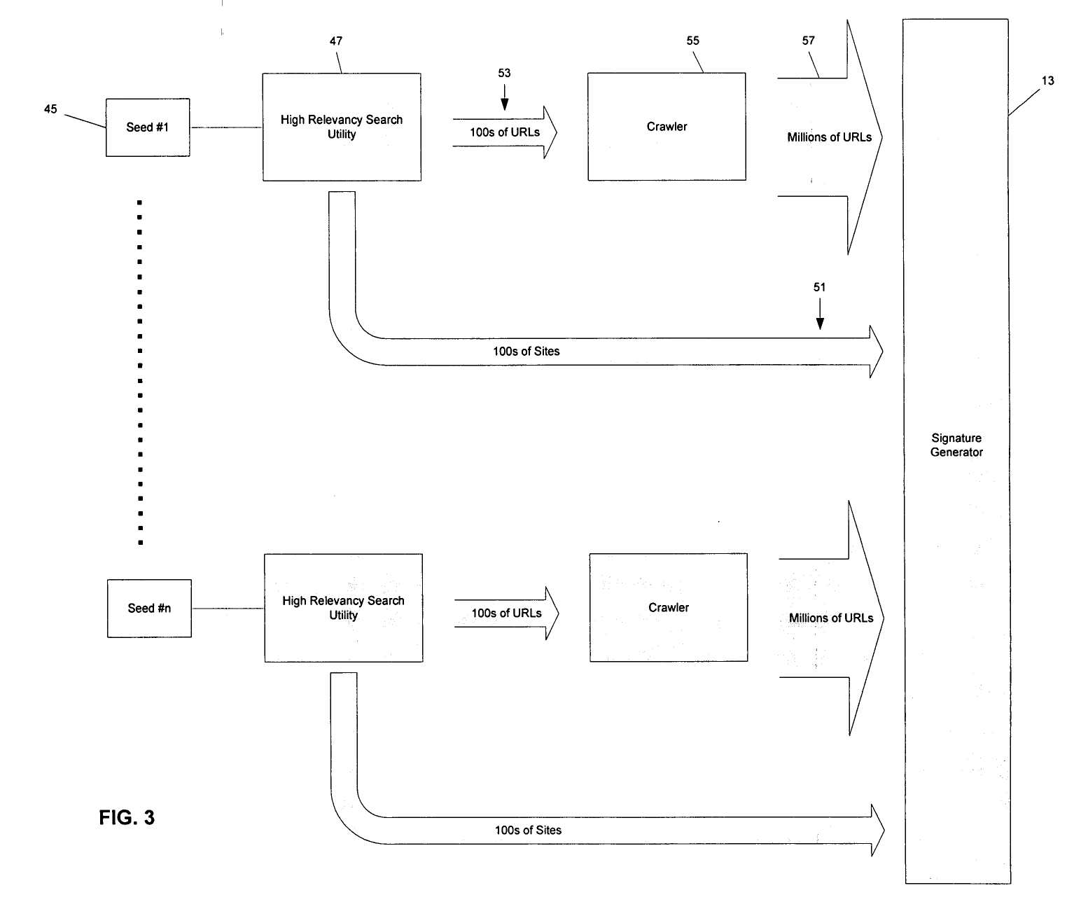

As noted above, documents from the unstructured data store 21 are also provided to the signature generator 13, and the signature generator 13 generates signatures that are used to create flagged and indexed documents that populate the indexed and flagged data store 27. To populate the indexed and flagged data store 27 with relevant documents, it is desirable to obtain documents that have a relatively high likelihood of being relevant to one of the categories for which a signature exists in the category signature data store 15. FIG. 3 illustrates a process for obtaining documents that results in a relatively large percentage of those documents being relevant to the categories in the category signature data store 15.

A plurality of seed terms 45 is used in the system 10. The seed terms may be selected or created such that each seed term is descriptive of a category. The seed terms 45 can be a single key word, a group of key words, or a phrase. A separate plurality of seed terms exists for each category. Each seed term 45 is provided to a high relevancy search utility 47.

The high relevancy search utility 47 returns a number of sites 51, the quantity of which is larger than the number of seed terms 45 used originally. The sites 51 returned by the high relevancy search utility 47 are parsed to extract each site's corresponding Uniform Resource Locater (“URL”) 53 (such as an address, on the Internet, of a web page). The URL and the entire content of each returned web page, for all the sites 51, are provided to the signature generator 13.

The URLs 53 returned by the high relevancy search utility 47 are used to seed a crawler 55. For each URL 53 received from the high relevancy search utility 47, the crawler 55 retrieves the information (e.g., a document) from the site. The crawler 55 analyzes each document to determine whether it contains any links or references (such as hyperlinks) to other documents. If the document contains such links, the crawler 55 follows these links and accesses each of the linked documents. The crawler 55 checks each of the linked documents for additional links, returning all that are found. This process continues until a predetermined number of links, called the crawl depth, have been accessed. The documents 57 returned are provided to the signature generator 13.

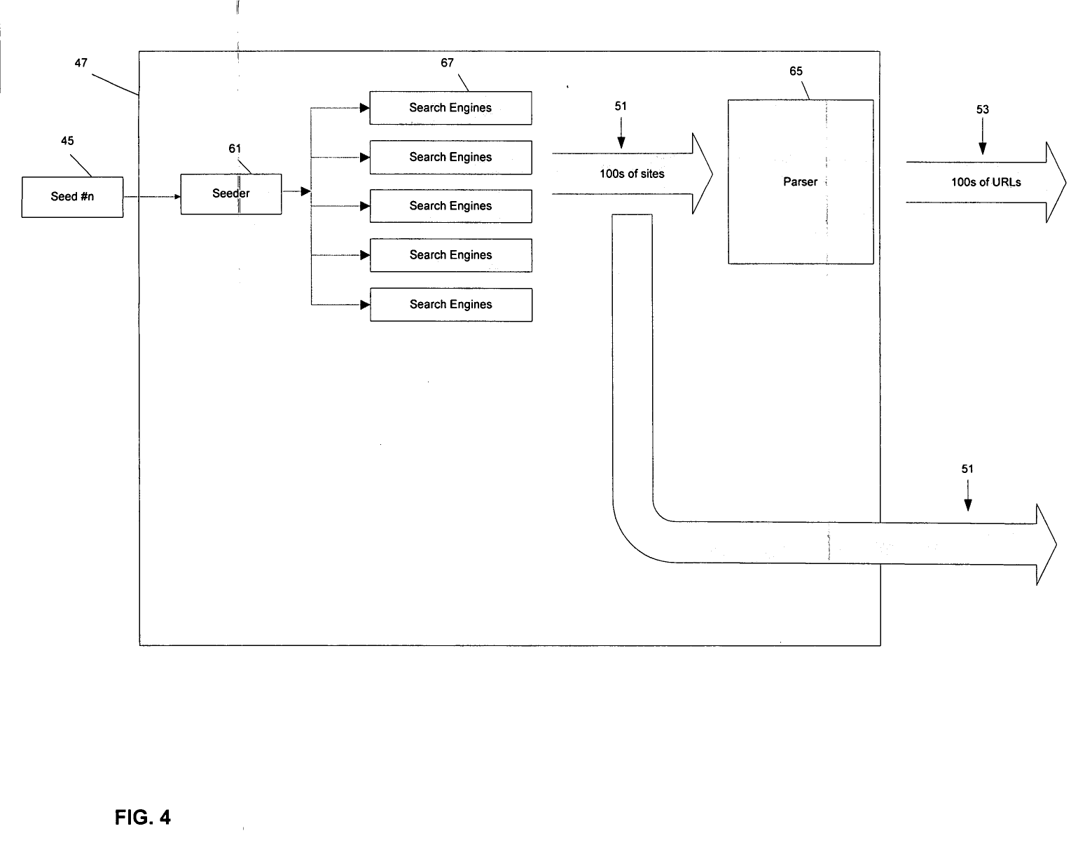

An embodiment of the high relevancy search utility 47 is shown in FIG. 4. The seed terms 45 are received by a seeder 61. The seeder 61 provides the seed terms 45 to a plurality of search engines 63 such as consumer or general purpose Internet search engines. Each of the search engines 63 returns a number of sites that relate to the seed term 45 in accordance with the search method employed by each of the search engines 63. The search engines 63 rank the sites returned according to a predetermined ranking or relevancy methodology selected by the operators of the search engines. Each search engine 63 returns a relatively large number of sites. A certain number of sites (e.g., the top one hundred), referred to as the selected sites 51, from each search engine 63 are chosen to act as seed terms for a crawler 55. To provide the crawler 55 with URLs, a parser 65 extracts the URL from each selected site 51. The selected sites 51 also provide documents to the signature generator 13 (see FIG. 3).

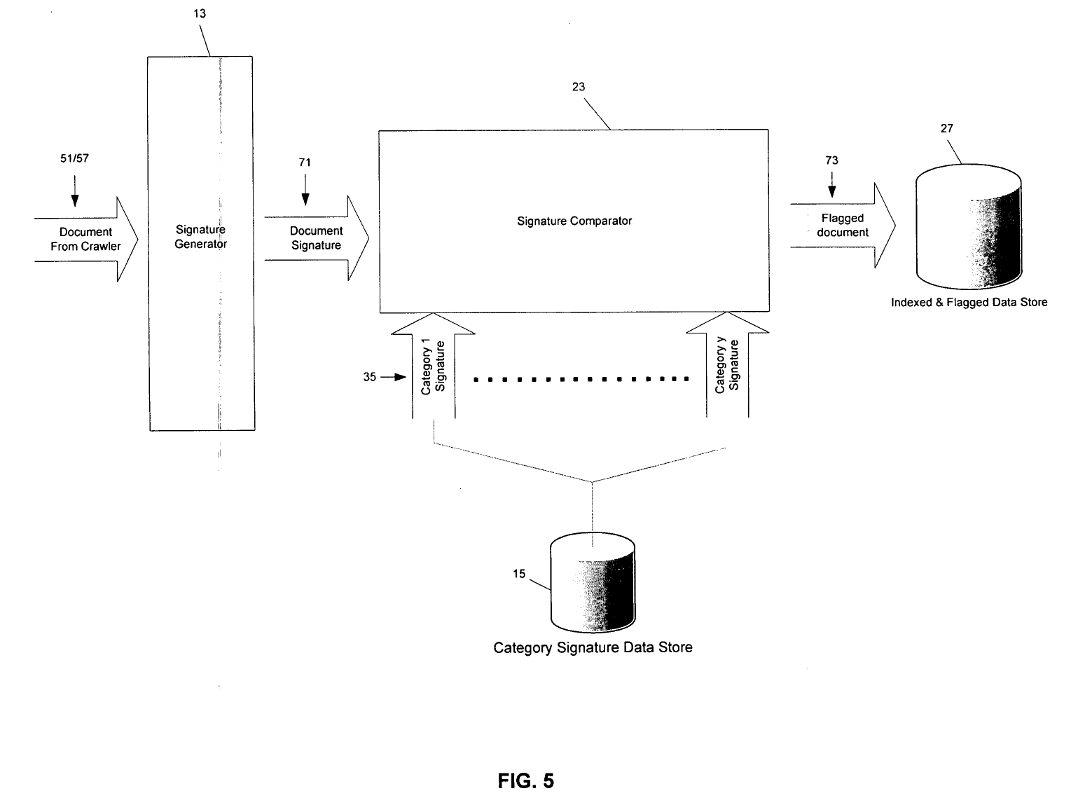

FIG. 5 represents a process for determining that a document is related to a category and flagging documents for each category that is related. In the embodiment shown, documents 51 and 57, received from the high relevancy search utility 47 and the crawler 55 of FIG. 3, are provided to the signature generator 13. For each document 51 and 57, the signature generator 13 generates a document signature 71 that identifies its content. The document signature 71 is provided to the signature comparator 23. The signature comparator 23 compares the document signature 71 to each category signature 35 stored in the category signature data store 15. The document is flagged for each category for which the comparison of its signature 71 and the category signature 35 produce a level of relevance that exceeds a predetermined threshold. A flagged document 73 is then indexed and stored in the indexed and flagged data store 27.

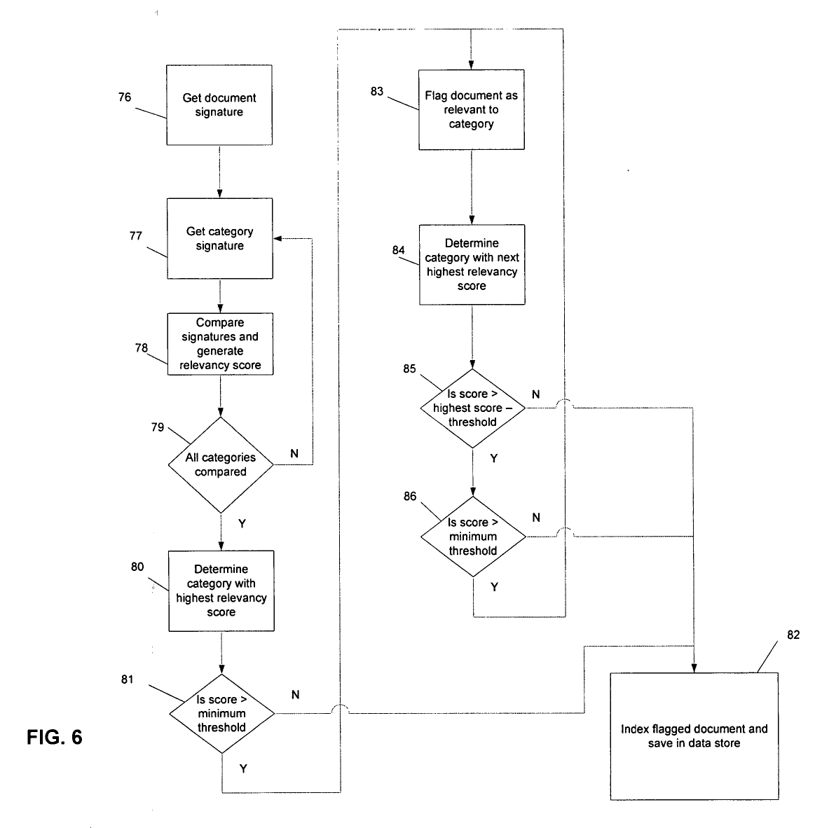

FIG. 6 illustrates processing carried out by the signature comparator 23. A document signature 71 is retrieved at step 76. At step 77 the first category signature 35 is retrieved. At step 78 the two signatures are applied to a process that compares their relevancy. A score is generated by this process indicating a level of relevancy between the document signature 71 and the category signature 35. Next, at step 79, the signature comparator 23 determines if all of the category signatures 37 have been compared to the document signature 71. If another category signature 35 exists, it is retrieved at step 77 and processing continues. If no such category signature 35 exists, it is determined, at step 80, for which category the document had the highest relevancy score. The highest relevancy score is compared, at step 81, to a first predetermined threshold to determine if it exceeds the minimum score necessary to be relevant. If the relevancy score does not exceed the first predetermined threshold, the document is indexed and stored, at step 82, in the indexed and flagged data store 27.

If the relevancy score exceeds the first predetermined threshold (step 81), the document is flagged at step 83 as being relevant to the category. Next, at step 84, the next highest relevancy score is determined. At step 85 the relevancy score is compared to a second threshold. The second threshold is the highest relevancy score reduced by a set or predetermined amount or percentage. If the relevancy score exceeds the second threshold, it is compared to the first predetermined threshold at step 86. If the relevancy score exceeds the first predetermined threshold, the document is flagged as relevant to the category at step 83 and processing continues.

If the relevancy score is determined not to exceed the second threshold, the document, including all flags, is indexed and stored, at step 82, in the indexed and flagged data store 27. Likewise, if the relevancy score is determined not to exceed the first predetermined threshold, the document is also is indexed and stored, at step 82, in the indexed and flagged data store 27.

A first example of the process illustrated in FIG. 6 follows in the paragraphs below.

In this first example, a vocabulary of four terms is created to describe two categories. The four terms in the vocabulary are:

Term 1—Man

Term 2—Woman

Term 3—Dog

Term 4—Cat

The two categories and the terms that describe them are:

| Category | Term 1 | Term 2 |
|---|---|---|
| People | Man | Woman |
| Animals | Dog | Cat |

Category signatures are created by identifying which terms in the vocabulary are related to each category as shown below.

| Vocabulary | People | Animals |
|---|---|---|
| Man | 1 | 0 |
| Woman | 1 | 0 |
| Dog | 0 | 1 |
| Cat | 0 | 1 |

Thus the category signatures are as follows:

People: 1100

Animals: 0011

In this example three documents are used. The documents are listed below.

Document 1:

The woman looked out the window just in time to see the dog chasing the cat. Afraid for the cat, the woman went to the door to see if she could help. By the time she arrived, both the cat and the dog were nowhere to be seen.

Document 2:

The man went to the store to buy some milk. While at the store he saw a woman who was an old friend. After a short conversation with the woman the man could not remember what he had come to the store for. So the man went back home without buying anything.

Document 3:

The sun was coming up early one morning as the waves gently came ashore. It was a cool morning but soon the warmth of the day would be felt. Off in the distance a man stood looking at the ocean.

Document signatures are created by counting the number of times each term in the vocabulary appears in the document. In the example documents, terms from the vocabulary are highlighted with bold face type. The table below shows the results for this example.

| Vocabulary | Doc 1 | Doc 2 | Doc 3 |
|---|---|---|---|
| Man | 0 | 3 | 1 |
| Woman | 2 | 2 | 0 |
| Dog | 2 | 0 | 0 |
| Cat | 3 | 0 | 0 |

Thus the document signatures are as follows:

Document 1: 0223

Document 2: 3200

Document 3: 1000

Comparing the document signatures to the category signatures produces a relevancy score for each document for each category as shown in the table below.

| Vocabulary | Doc 1 | People | Score |
|---|---|---|---|
| Man | 0 | 1 | 0 |
| Woman | 2 | 1 | 2 |
| Dog | 2 | 0 | 0 |
| Cat | 3 | 0 | 0 |
| Vocabulary | Doc 1 | Animals | Score |
| Man | 0 | 0 | 0 |
| Woman | 2 | 0 | 0 |
| Dog | 2 | 1 | 2 |
| Cat | 3 | 1 | 3 |
| Vocabulary | Doc 2 | People | Score |
| Man | 3 | 1 | 3 |
| Woman | 2 | 1 | 2 |
| Dog | 0 | 0 | 0 |
| Cat | 0 | 0 | 0 |
| Vocabulary | Doc 2 | Animals | Score |
| Man | 3 | 0 | 0 |
| Woman | 2 | 0 | 0 |
| Dog | 0 | 1 | 0 |
| Cat | 0 | 1 | 0 |
| Vocabulary | Doc 3 | People | Score |
| Man | 1 | 1 | 1 |
| Woman | 0 | 1 | 0 |
| Dog | 0 | 0 | 0 |
| Cat | 0 | 0 | 0 |
| Vocabulary | Doc 3 | Animals | Score |
| Man | 1 | 0 | 0 |
| Woman | 0 | 0 | 0 |
| Dog | 0 | 1 | 0 |
| Cat | 0 | 1 | 0 |

Thus the relevancy scores are as follows:

| | People | Animals |
|---|---|---|
| Document 1: | 2 | 5 |
| Document 2: | 5 | 0 |
| Document 3: | 1 | 0 |

Document 1 is flagged as related to the category animals but is not flagged as related to the category people. Document 2 is flagged as related to the category people but is not flagged as related to the category animals. Document 3 is flagged as related to category people but is not flagged as related to the category animals.

Document 1 has twice as many references to people as document 3, but is not flagged as related to the category people while document 3 is. This is the result of document 1 being more related to the category animals and less related to the category people. If document 1 had five references to the category people it would have been flagged as related to both the category people and the category animals. A predetermined threshold is utilized to determine how significant the difference in the relevancy score for the most relevant category and the relevancy score for another category can be for the second category to be considered relevant. In the case of document 1, the most relevant category, animals, had a relevancy score of 5. The next category, people, had a relevancy score of 2. The difference is 60%. If the threshold to be considered relevant were set at 20% below the most relevant category's relevancy score, document 1 would need a relevancy score of 4 or more for the category of people for document 1 to be considered relevant to the category people.

A second threshold may also be used to determine if a document is relevant to any category. To ensure documents that are not related to a category are not flagged as being relevant, a minimum relevancy score is used. If, in the example, a minimum threshold of 2 were set, document 3 would not be flagged as being relevant to either category.

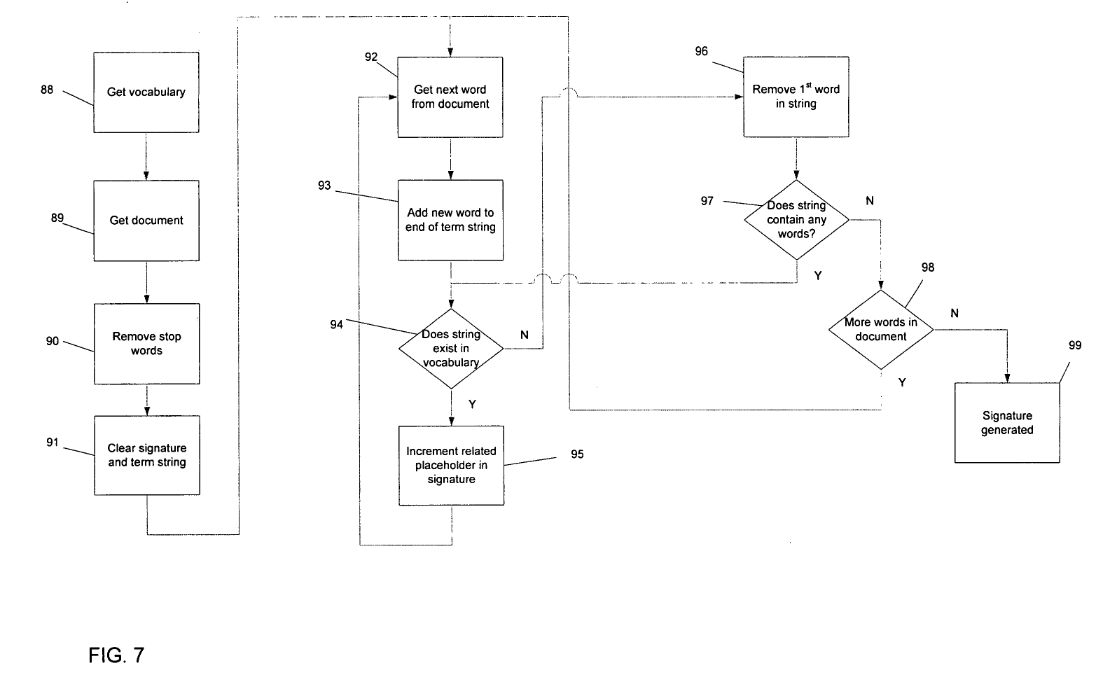

One embodiment of the process of the signature generator 13 to generate a signature is illustrated by FIG. 7. At step 88 the signature generator 13 retrieves a vocabulary from the first structured data store 11. The vocabulary in this embodiment is an ordered static set of terms. As noted, terms may consist of words, groups of words, or phrases. Next, at step 89, the signature generator 13 receives a document. At step 90 the signature generator 13 removes all stop words in the document. Stop words are common words (e.g., the, it, to, etc.) that impart relatively little meaning. Next the signature data store and a term string are cleared at step 91. At step 92 the signature generator 13 retrieves the first word in the revised document. A term string is created by concatenating each new word retrieved to the end of the string at step 93. At step 94 the string is compared to terms in the vocabulary. If there is a match, the place holder for the term in the signature is incremented at step 95. The signature generator 13 then retrieves the next word from the document at step 92.

If the term string does not exist in the vocabulary (step 94), the first word of the term string is removed at step 96. If, at step 97, the term string contains one or more words, processing continues at step 94 with a determination if the new term string exists in the vocabulary.

At step 97, if the string does not contain any words after the first word is removed, the document is checked, at step 98, to determine if it contains more words. If it does, processing continues at step 92 with the retrieval of the next word. If it does not, the document signature is complete, as shown at step 99.

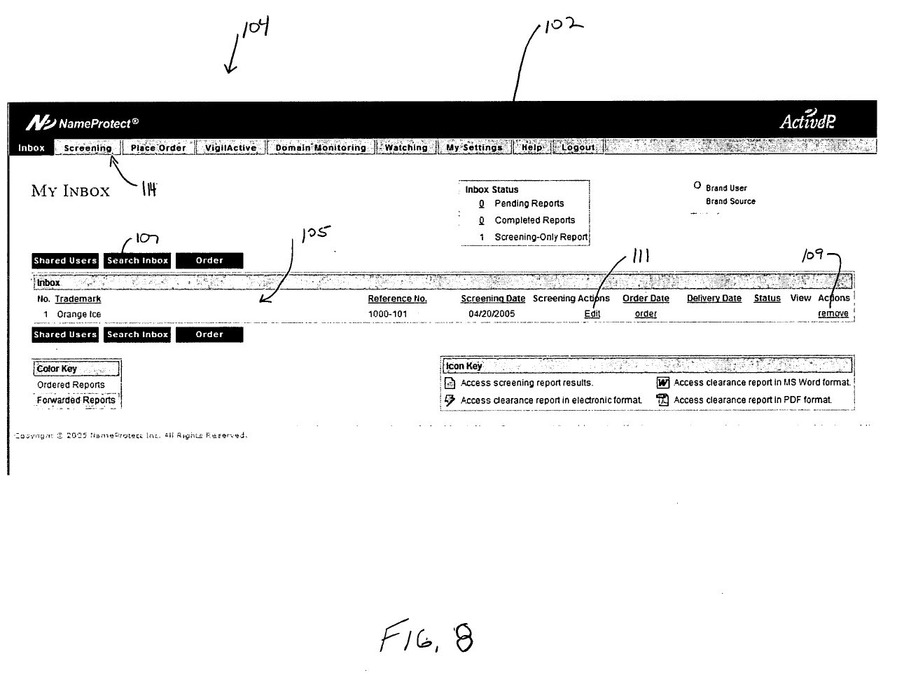

Exemplary processes performed by and with the workflow module 29 and user interface screens generated by the workflow module 29 are illustrated in FIGS. 8-19.

First, a user logs on to the workflow system 29. Such an initial connection may take place through an Internet portal or web page 102 (FIG. 8). Once a user logs on, an inbox 104 is displayed. The inbox 104 may include a list of sessions or search results 105 that the user has performed or otherwise has access to. The inbox 104 may also include a number of mechanisms allowing a user to choose from a number of options. For example, a user may choose to search the inbox by selecting a search inbox button 107, or remove a session from the inbox by selecting a remove action link or function 109. Searching the inbox allows a user to identify the sessions or search results the user has access to. A user may also edit a session by selecting an edit function 111. A new session may be viewed by selecting a screening tab 114.

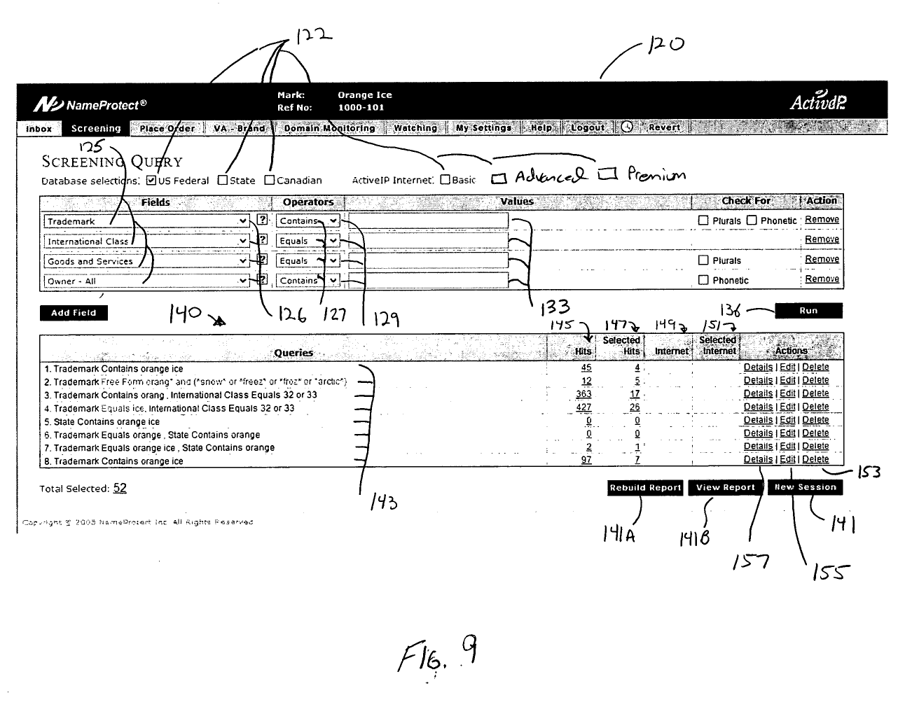

The edit function 111 links a user to a query listing screen 120 (FIG. 9). The query listing screen 120 may include a number of user selected options with corresponding input mechanisms.

In the embodiment shown, a user may select or choose the databases that the user desires to search. The query listing screen 120 includes checkboxes 122 corresponding to a “US Federal,” “State,” “Canadian,” and an unstructured database, which may be selected by choosing one of three options “Basic,” “Advanced,” and “Premium.” Once the user has selected the databases to be searched, one or more fields 125 may be selected using drop down menus 126. The fields 125 may include fields from the USPTO trademark database and fields from searches performed on unstructured data stores, such as the Internet. In addition, an operator 127 from operator menus 129 may be selected. The operators may include typical search operators based on Boolean and mathematical operators such as “contains,” “equals,” “and,” “or,” and the like. Search terms or criteria may be entered in input boxes 133.

The query is executed by selecting a run button 136. The query is executed on the indexed and flagged data store 27. Results are saved in a query data store and the query is added to an executed query list 140. Results include data on how the query was built plus the entire record for every hit. The record is retrieved from the indexed and flagged data store 27. A “New Session” button 141 clears the executed query list 140 and begins a new session. The query listing screen 120 also includes a rebuild report button 141A and a view report button 141B, which are discussed below.

The executed query list 140 includes a number of executed queries 143. The query list 140 also includes a “Hits” column” 145 that provides an indication of the number of matching records found in the selected structured data stores, a “Selected Hits” column 147 that provides an indication of the number of records users selected from the structured data store matching records, an “Internet” column 149 that provides an indication of the number of matching records that have been found in the unstructured data stores, a “Selected Internet” column 151 that provides an indication of the number of records users selected from the unstructured data store matching records.

The executed query list 140 includes features that allow users to perform a number of actions on the executed queries 143. Selecting a “Delete” function 153 removes the executed query from the executed query list 140. Selecting an “Edit” function 155 displays the query parameters for the selected query, and the fields 125, operators 127, criteria 133 and selected checkboxes 122 are shown. Modifications may be made to the query and, if desired, the query may be executed by selecting the run button 136. The new query is added to the executed query list 140. Selection of a “Details” function 157 from the executed query list 140 displays the details of the query including all of its parameters.

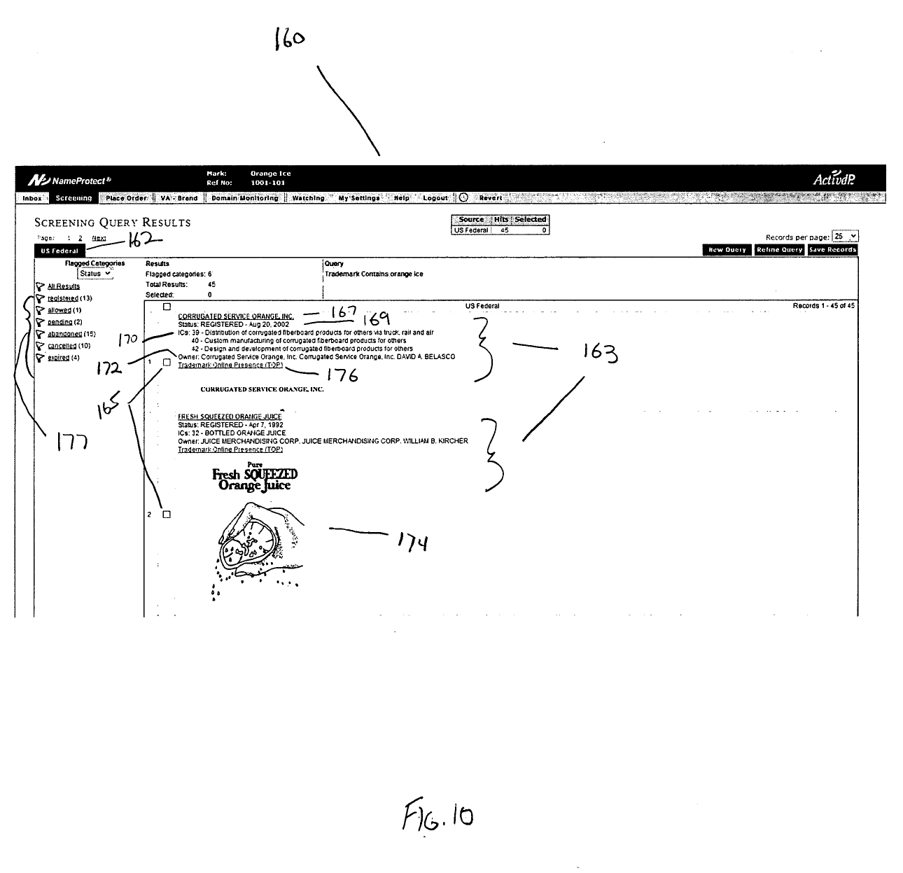

Following execution of a query by selecting the run button 136, or following selection of an item in the hits or Internet columns 145 and 149, a matching records screen 160 for the query is displayed (FIG. 10). A tab 162 is shown for each database included in the query. Selecting the tab 162 displays matching records 163 from the selected database for the query. In the embodiment shown, the databases have a selection box 165 next to each matching record 163. Clicking the selection box 165 identifies its matching record 163 for inclusion in a report.

For structured databases, the matching records screen 160, displays a title 167, a registration status 169, and IC affiliation 170, owner 172, mark 174, links to any state registrations (not shown), and a “Trademark Online Presence” link 176.

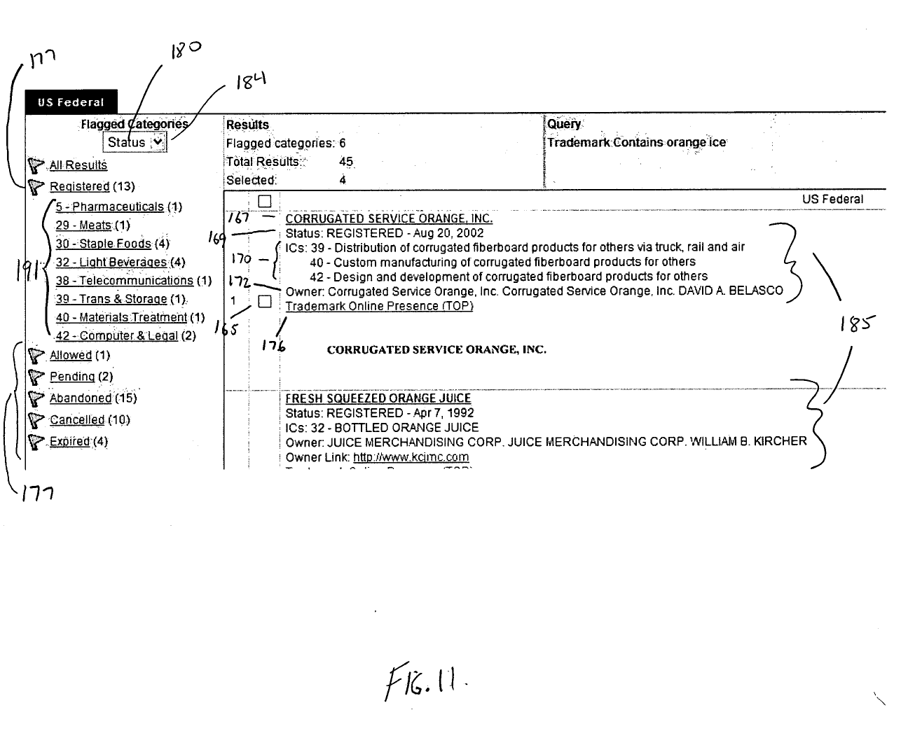

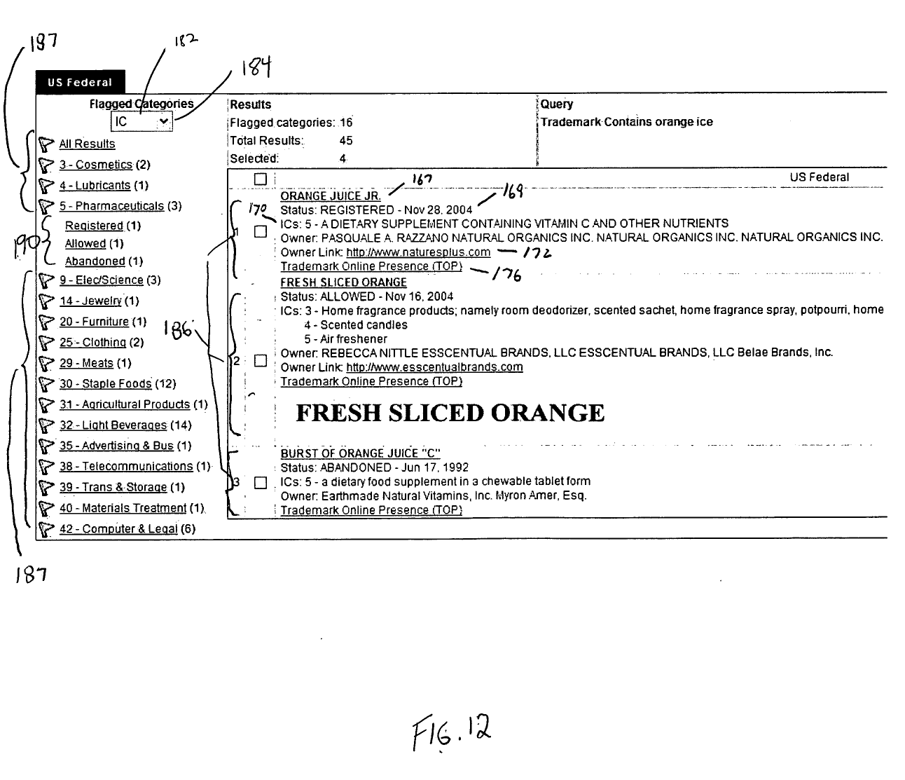

Each matching record 163 is assigned to two or more categories, a status category and one or more International Class categories. Status categories relate to the status of a matching record's trademark registration. In FIG. 10 several status categories 177 are shown and include: registered, allowed, pending, abandoned, cancelled, and expired. International Class categories correspond to the International Classes of Trade. The matching records screen 160 displays either the status 180 (FIG. 11) or IC 182 (FIG. 12) categories. A drop down box 184 enables selection of which category list to display. Selecting a category filters the matching records 163 shown on the matching records screen 160. Status matching records 185 (FIG. 11) are matching records 163 that are affiliated with the status category 180 and are displayed when a status category 177 is selected. IC matching records 186 (FIG. 12) are matching records 163 that are affiliated with the IC category 182 and are displayed when an IC category 187 is selected. Subcategory lists 190 and 191 also display beneath the selected category. For a status category 177, the subcategory list 191 displays the IC categories for which the status matching records 185 have an affiliation. For an IC category 187, the subcategory list 190 displays status categories for which IC matching records 186 have an affiliation.

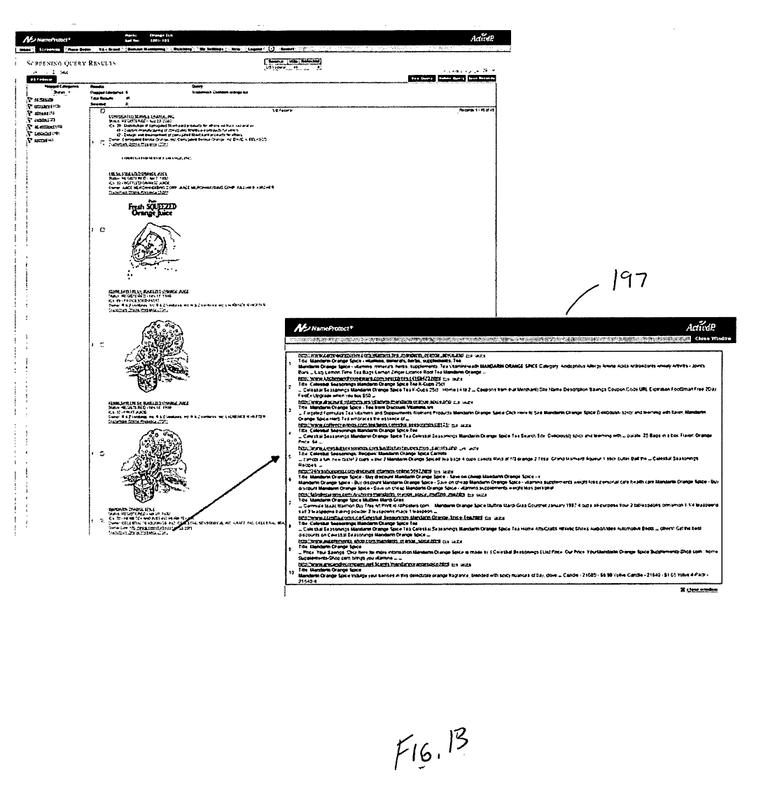

Selecting the “Trademark Online Presence” (“TOP”) link 176 opens a TOP window 197 (FIG. 13). The TOP window 197 displays a group of ranked results from a network search such as the top ten Internet search results from a query consisting of the title 167 of a selected matching record 163. Such results may be obtained by searching on the title query using an Internet search engine.

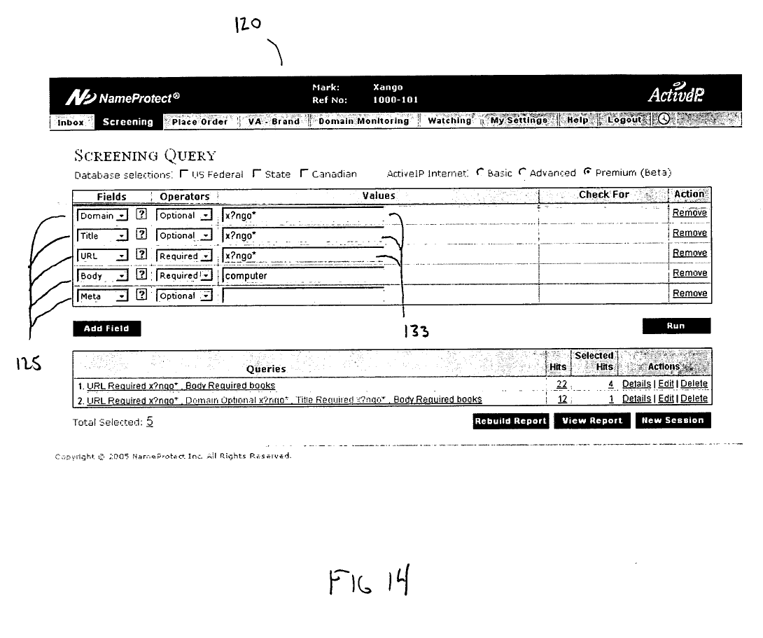

For unstructured databases, the query listing screen 120 contains fields 125 which may include URL, domain, title, body, and meta (FIG. 14). Criteria 133 for unstructured databases may contain wildcard characters such as “?” for a single character wildcards or “*” for a multiple character wildcards.

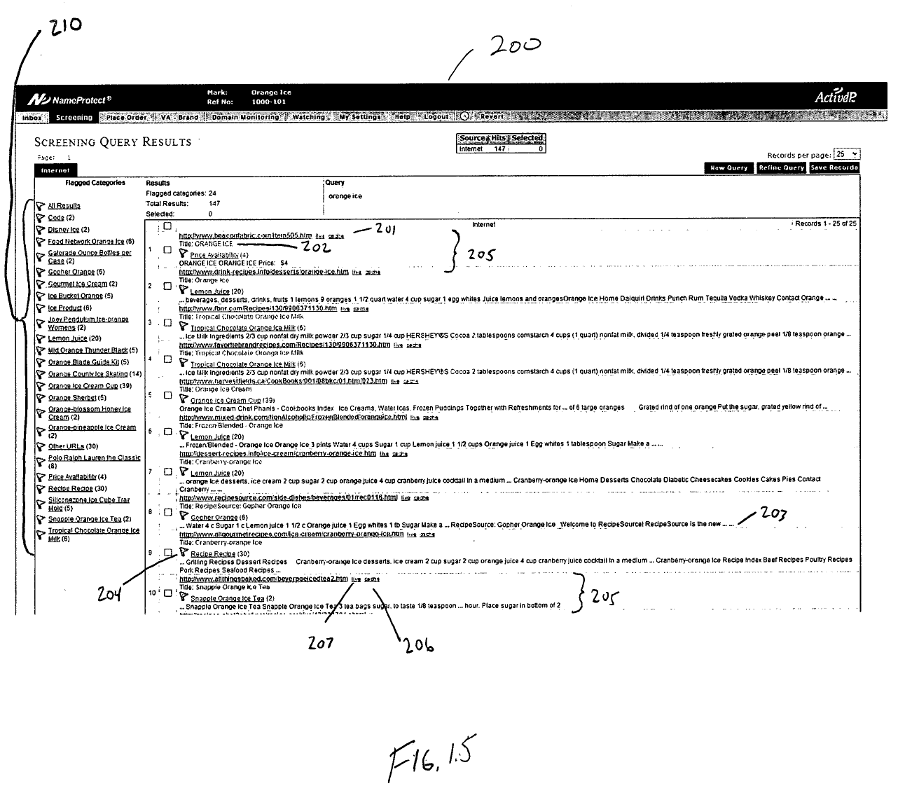

Additionally, for unstructured databases, the workflow tool 29 displays an unstructured matching records screen 200, a URL 201, a title 202, a snippet 203 of information, and a list of categories 204 that an unstructured matching record 205 is affiliated with (FIG. 15). A cache link 206 to display the copy of the unstructured matching record 205 in the linked and flagged data store 27 is available for each unstructured matching record 205. In addition, a live link 207 to display the actual record of the unstructured matching record 205 from its original data store is available for each unstructured matching record 205.

A list of categories 210 is displayed on the unstructured matching records screen 200. Categories 210 are determined by examining all the unstructured matching records 205 and determining terms common to more than one unstructured matching record 205. In one embodiment, all such terms become categories 210 and all unstructured matching records 205 containing those terms are assigned to the categories 210 associated with those terms. Selecting a category 210 filters out unstructured matching records 205 that do not contain the terms associated with the selected category 210 and displays only the unstructured matching records 205 that do contain the terms associated with the selected category 210.

As noted above, the query listing screen 120 includes a rebuild report button 141. A. Selecting this button causes the workflow tool 29 to compile all of the records selected from the structured data store matching records 163 and all of the records selected from the unstructured data store matching records 205 for all of the executed queries 143 and saves them in a report data store (not shown).

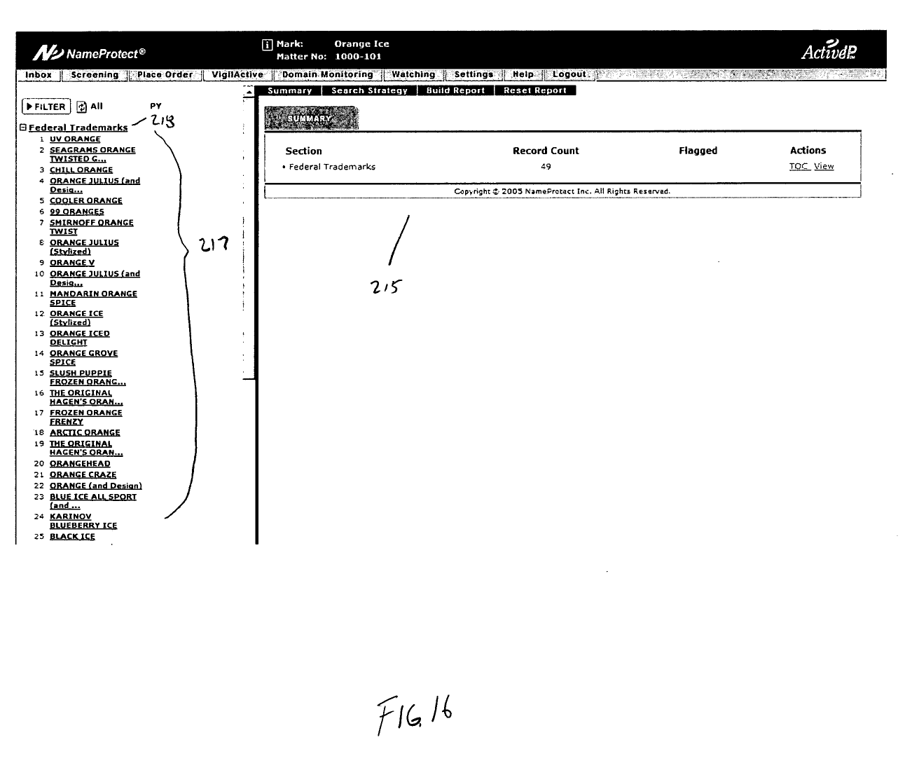

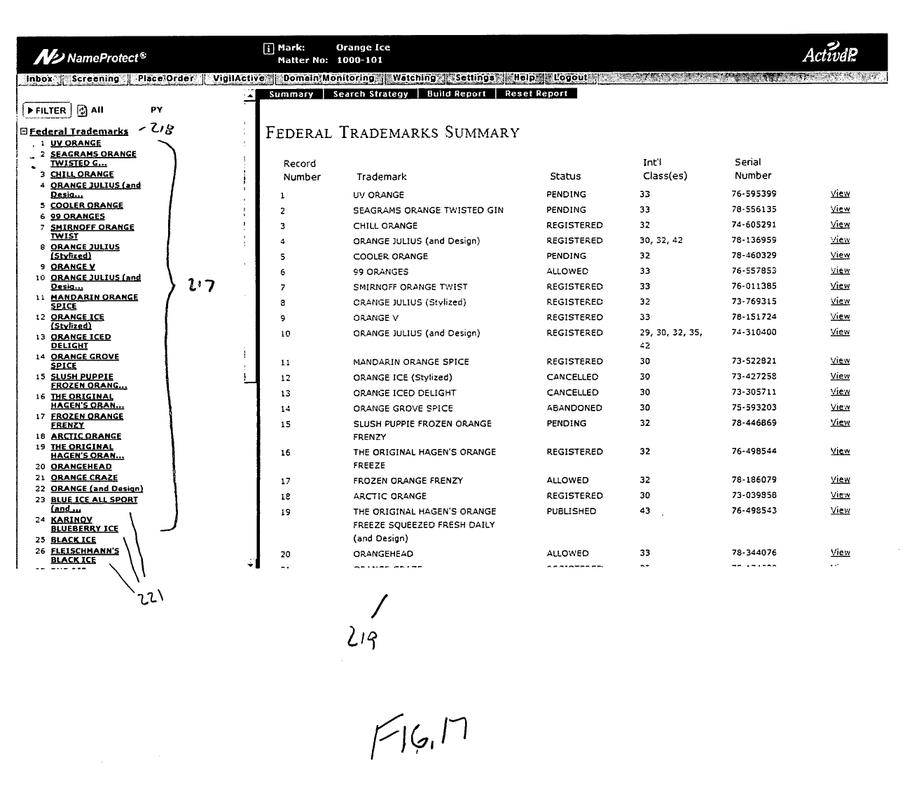

Selecting the view report button 141B displays a summary 215 of the selected structured data store matching records 163 and the selected unstructured data store matching records 205 (FIG. 16). A selected records list 217 displays all of the structured data store matching records 163 and all of the unstructured data store matching records 205 sorted by data store 122. Selecting a data store 218 from the selected records list 217 displays summary information 219 for each selected matching record 221 for the data store 218 chosen (FIG. 17).

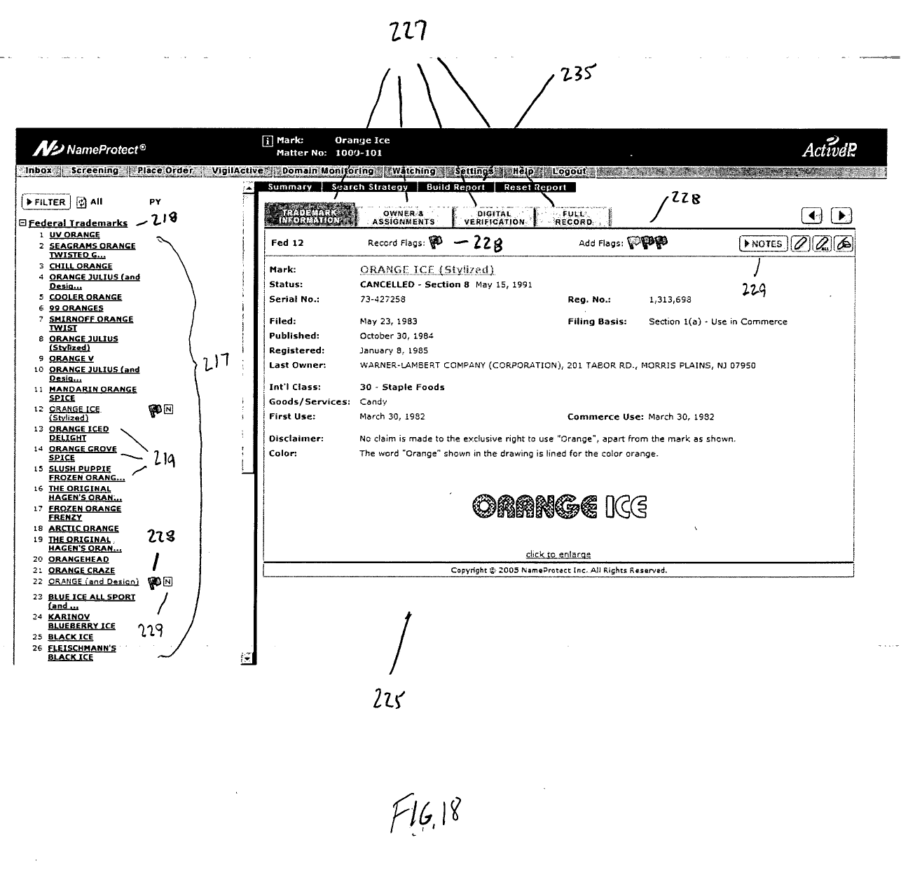

Selecting a record 221 from the selected records list 217 displays details 225 of the matching record chosen (FIG. 18). Tabs 227 provide access to subsets of data on the record chosen. Users may add user defined flags 228 to records to include the record in a report or to draw another user's attention to the record. Notes 229 may also be added to the record by users. Notes 229 can be included in reports or they may be left out of the report.

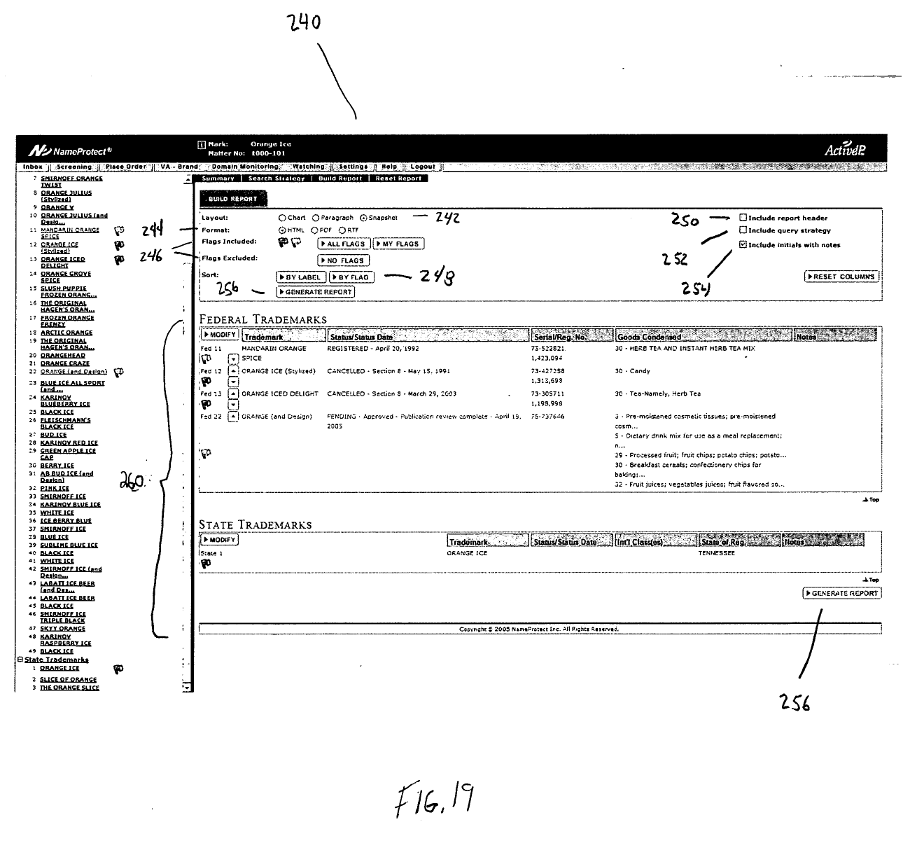

A “Build Report” tab 235 displays a report generation screen 240 (FIG. 19). The report generation screen 240 includes report formatting functions such as layout 242, format 244, flags to include 246, sorting options 248, report header inclusion 250, query strategy inclusion 252, and note inclusion 254. Users select options desired in a report. Selecting a generate report button 256 cause a report 260 to be displayed on a screen or terminal (not shown). The report 260 reflects the user's selections.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. As should also be apparent to one of ordinary skill in the art, some systems and components shown in the figures are models of actual systems and components. Some control components described are capable of being implemented in software executed by a microprocessor or a similar device or of being implemented in hardware using a variety of components. Thus, the claims should not be limited to the specific examples or terminology.

What is claimed is:

1. An information retrieval system comprising:
a structured data store;
a signature generator configured to receive data from the structured data store, to create a category signature based on the data received from the structured data store, to receive search results from at least one crawler, and to generate a document signature based on the results from the at least one crawler;
a data store populated with a set of category signatures;
a search utility configured to receive a seed, to provide the seed to a plurality of search engines, each search engine configured to generate a search result set, to parse each search result set, and to return a relevant data set;
a crawler configured to receive the relevant data set and to generate a second set of search results with a relevancy to a category, where the second set of results is larger than the first set of results;
a signature comparator configured to receive at least one document signature and at least one category signature, compare the at least one document signature and the at least one category signature, and generate flagged records; and
an indexed data store populated with flagged records from the signature comparator.

2. The system of claim 1 further comprising:
a workflow module configured to provide a user interface, the user interface configured to allow a user to query the indexed data store.

3. The system of claim 2 wherein the workflow module comprises a tool for sharing search results amongst a plurality of users.

4. The system of claim 1 further comprising a plurality of document data stores each separately searchable.

5. An information retrieval system comprising:
a structured data store;
a signature generator configured to receive groups of related data from the structured data store, to create a category signature based on the data received from the structured data store, to receive a document, and to generate a document signature based on the document;
a data store populated with a set of category signatures;
a signature comparator configured to receive at least one document signature and at least one category signature, compare the at least one document signature and the at least one category signature, and generate flagged records; and
an indexed data store populated with flagged records from the signature comparator.

6. The system of claim 5 further comprising a workflow module configured to provide a user interface, the user interface configured to allow a user to query the indexed data store.

7. The system of claim 6 wherein the workflow module comprises a tool for sharing search results amongst a plurality of users.

8. The system of claim 5 further comprising a plurality of document data stores each separately searchable.

9. A method of creating a structured data store from an unstructured data store, the method comprising:
generating search results from a search of the unstructured data store;
providing the search results to a signature generator to create a document signature;
generating a category signature based on information from a structured data store;
providing the document signature and the category signature to a signature comparator to generate a flagged record; and
populating a data store with the flagged record.

10. The method of claim 9 further comprising indexing the data store populated with the flagged record.

11. The method of claim 10 further comprising providing a workflow process that allows users to search the data store populated with the flagged record.

12. The method of claim 9 further comprising providing a workflow module having a tool that permits sharing of search results amongst a plurality of users.

13. A method of creating a structured data store from an unstructured data store, the method comprising:
generating search results from a search of an unstructured data store;
providing the search results to a signature generator to create a document signature;
generating a category signature from a structured data store;
providing the document signature and the category signature to a signature comparator to generate a relevancy index;
determining whether the relevancy index exceeds a threshold;
generating flagged records if the relevancy index exceeds the threshold; and
populating a first data store with flagged records.

14. The method of claim 13 further comprising indexing the data store populated with the flagged records.

15. The method of claim 14 further comprising providing a workflow process allowing users to search the data store populated with the flagged records.

16. The method of claim 13 further comprising sharing search results amongst a plurality of users.

17. A method of creating a structured data store from a group of documents, the method comprising:
providing documents to a signature generator to create a document signature;
generating a category signature from one or more related documents;
providing the document signature and the category signature to a signature comparator to generate a flagged record; and
populating a data store with the flagged record.

18. An apparatus for creating a data store of related documents, the apparatus comprising:
a set of documents segmented into related groups;
a signature generator to create a unique signature for each document group;
a data store populated with signatures for each group of documents;
a signature created by the signature generator for a document;
a signature comparator to flag related documents; and
a data store to hold related, flagged documents.

19. A system for creating a data store of related documents comprising:
a plurality of documents segmented into groups of related documents;
a device to compare the magnitude of the relationship between a document and each group of related documents and to flag documents where the relationship exceeds a threshold; and
a data store to hold the flagged documents.

20. A method to identify relevancy of documents, the method comprising:
generating a signature defining a first set of documents;
generating a second signature defining a second set of documents;
comparing the two signatures;
generating a relevancy index; and
determining the relevancy of the two sets of documents based on a threshold.

21. A system to remove irrelevant records from a query, the system comprising:
a structured data store including groups of related documents;
a signature generator configured to receive groups of related documents and generate a group signature;
a data store of group signatures;
a signature generator configured to receive documents and provide a signature identifying each document;
a signature comparator to compare the signature of a document to the group signatures in the data store of group signatures, flag documents with a high degree of relevancy to one or more groups, and provide the documents to an indexed data store;
a query module to query one or more groups; and
a search engine configured to search the indexed data store and return documents relevant to the chosen group.

22. A method to search a data store, the method comprising:
generating a list of terms descriptive of a category;
generating a set of search results from a plurality of search engines;
parsing the search result sets; and
crawling a data store based on the parsed search result set.

23. The method of claim 13 further comprising:
storing a second result set in a data store.

24. A system for crawling a data store, the system comprising:
a set of terms descriptive of a category;
a plurality of search engines configured to receive the set of terms and generate a first search result;
a parser to filter the first search results; and
a crawler configured to receive the parsed results and to generate a second set of results, where the second set of results is larger than the first set of results.

25. The system of claim 24 further comprising:
a data store for saving results.

26. An information retrieval system comprising:
an indexed data store containing data from a plurality of structured and unstructured data stores;
a query builder configured to
choose at least one of the plurality of structured and unstructured data stores to include in a query,
select fields related to the at least one data store chosen, and
accept criteria from a user interface for the selected fields; and
a search utility to search the indexed data store and return results matching the query built.

27. The system of claim 26 configured to operate on an Internet portal.

28. The system of claim 26 wherein results are grouped and displayed according to a data store origin.

29. The system of claim 26 wherein specific data for each result is displayed.

30. The system of claim 26 wherein categories are created based on correlated data in the results.

31. The system of claim 30 wherein results are displayed by category.

32. The system of claim 26 wherein each result is linked to a record in the indexed data store.

33. The system of claim 26 wherein each result is linked to a record in a data store of origin.

34. The system of claim 26 configured to allow a user to select zero or more results for entry in a data store.

35. The system of claim 34 wherein the results derive from a plurality of searches.

36. The system of claim 35 configured to allow a user to select results to be flagged.

37. The system of claim 36 configured to generate a report a report.

38. The system of claim 34 configured to allow a user to annotate zero or more selected results.

39. The system of claim 26 configured to allow a plurality of users to access the query.

40. The system of claim 26 configured to allow a plurality of users to access the results.

41. The system of claim 26 configured to accept criteria that include one or more terms and the terms include one or more wild card characters.

42. An information retrieval system comprising:
an indexed data store containing data from a plurality of structured and unstructured data stores;
a query builder configured to
choose at least one of the plurality of structured and unstructured data stores to include in a query,
select fields related to the at least one data store chosen, and
accept criteria from a user interface for the selected fields; and
a search utility to search the indexed data store and return results matching the query built; the search utility configured to allow a user to select zero or more results for entry in a data store and to perform multiple searches.

43. The system of claim 42 configured to operate on an Internet portal.

44. The system of claim 42 configured to group and display results according to a data store origin.

45. The system of claim 42 configured to display data for each result.

46. The system of claim 42 configured to create categories based on correlated data in the results.

47. The system of claim 46 configured to display results by category.

48. The system of claim 42 wherein each result is linked to a record in the indexed data store.

49. The system of claim 42 wherein each result is linked to a record in a data store of origin.

50. The system of claim 42 configured to allow a user to select zero or more results for entry in a data store.

51. The system of claim 50 wherein the results derive from a plurality of searches.

52. The system of claim 51 configured to allow a user to select results to be flagged.

53. The system of claim 52 configured to generate a report.

54. The system of claim 50 configured to allow a user to annotate zero or more selected results.

55. The system of claim 42 configured to allow a plurality of users to access the query.

56. The system of claim 42 configured to allow a plurality of users to access the results.

57. The system of claim 42 configured to accept criteria that include one or more terms and the terms include one or more wild card characters.

58. An information retrieval system comprising:
an indexed data store containing data from a plurality of structured and unstructured data stores;
a query builder configured to
choose at least one of the plurality of structured and unstructured data stores to include in a query,
select fields related to the at least one data store chosen, and
accept criteria from a user interface for the selected fields, and
receive query input from a plurality of users; and
a search utility to search the indexed data store and return results matching the query built; and

59. The system of claim 58 configured to operate on an Internet portal.

60. The system of claim 58 configured to group and display results according to a data store origin.

61. The system of claim 58 configured to display data for each result.

62. The system of claim 58 configured to create categories based on correlated data in the results.

63. The system of claim 62 configured to display results by category.

64. The system of claim 58 wherein each result is linked to a record in the indexed data store.

65. The system of claim 58 wherein each result is linked to a record in a data store of origin.

66. The system of claim 58 configured to allow a user to select zero or more results for entry in a data store.

67. The system of claim 66 wherein the results derive from a plurality of searches.

68. The system of claim 67 configured to allow a user to select results to be flagged.

69. The system of claim 68 configured to generate a report.

70. The system of claim 66 configured to allow a user to annotate zero or more selected results.

71. The system of claim 58 configured to allow a plurality of users to access the query.

72. The system of claim 58 configured to allow a plurality of users to access the results.

73. The system of claim 58 configured to accept criteria that include one or more terms and the terms include one or more wild card characters.
